(19) United States
(12) Patent Application Publication
(10) Pub. No.: US 2026/0077649 A1
(43) Pub. Date: Mar. 19, 2026

(54) METHOD OF CONTROLLING IN-VEHICLE DRIVING SOUND USING SOUND QUALITY INDEX-BASED GENERATIVE AI

(71) Applicants: HYUNDAI MOTOR COMPANY, Seoul (KR); KIA CORPORATION, Seoul (KR)

(72) Inventors: Kyoung-Jin NOH, Hwaseong-si (KR); Dong-Chul LEE, Hwaseong-si (KR); In-Soo JUNG, Hwaseong-si (KR)

(21) Appl. No.: 19/085,943

(22) Filed: Mar. 20, 2025

(30) Foreign Application Priority Data
Sep. 13, 2024 (KR) 10-2024-0126054

(51) Int. Cl. B60K 35/26; G06N 3/0455; G06N 3/08

(52) U.S. Cl. CPC B60K 35/26; G06N 3/0455; G06N 3/08

(57) ABSTRACT

A method of controlling sound using a sound quality index-based generative artificial intelligence (AI) of the present disclosure includes inputting a controller area network (CAN) signal and a vibration signal of a vehicle to a neural encoder, forming, by a controller, a latent vector for the CAN signal and vibration signal processed in the neural encoder, outputting, by the latent vector, sound through a neural decoder, and outputting a sound quality index (SQI) through a neural network, wherein the neural decoder may fixedly use the parameters of the neural decoder of which training is completed, the neural network may fixedly use the neural network of which training is completed from the input of the CAN signal and vibration signal of the vehicle, and the neural encoder may be trained while the sound quality index output through the neural network is compared with a target sound quality index.

### CROSS-REFERENCE TO RELATED APPLICATION

This application claims priority to Korean Patent Application No. 10-2024-0126054, filed on Sep. 13, 2024, which is incorporated herein by reference in its entirety.

### TECHNICAL FIELD

The present disclosure relates to a technology of controlling in-vehicle driving sound, and more specifically, to a control method of optimizing and personalizing in-vehicle driving sound using a sound quality index-based artificial intelligence (AI).

### BACKGROUND

Driving sound within a vehicle cabin is generated by reproducing virtual sounds through indoor speakers based on vehicle driving information, such as speed, RPM, torque, acceleration, gear stage, pedal, or vibrations. The virtual sound can be tuned by adjusting gain parameters for each order of a signal processing algorithm, either through repeated testing based on a developer's subjective evaluation or by utilizing artificial intelligence (AI).

While this method enables driving sound tuning with minimal computation, it is limited in that tone adjustments are restricted to controlling the intensity of order components.

Accordingly, there is a need for a control method that can automatically optimize and personalize driving sound based on a sound quality index (powerful, dynamic, pleasant, sporty) derived from listening evaluations, leveraging generative AI in the sound synthesis process.

### SUMMARY

The present disclosure is directed to a control method of automatically optimizing and personalizing driving sound based on a sound quality index (powerful, dynamic, pleasant, sporty) derived from listening evaluations, leveraging a generative AI in the sound synthesis process.

According to one aspect of the present disclosure, a method of controlling sound using a sound quality index-based generative artificial intelligence (AI) can include inputting sound generated from a vehicle to a neural encoder, forming, by a controller, a latent vector for the sound in the neural encoder, and outputting, by the latent vector, sound through a neural decoder.

In addition, the controller may simultaneously train the neural encoder and the neural decoder by comparing the output sound with target sound.

In addition, the sound may simultaneously train the neural encoder and the neural decoder for engine or motor generation sound.

A method of controlling sound using a sound quality index-based generative artificial intelligence (AI) may include inputting a controller area network (CAN) signal and a vibration signal of a vehicle to a neural encoder, forming, by a controller, a latent vector for the CAN signal and vibration signal processed in the neural encoder, and outputting, by the latent vector, sound through a neural decoder, wherein the neural decoder may fixedly use the parameters of a neural decoder of which training is completed from the input of the sound.

In addition, the controller may train the neural encoder by comparing the sound output from the neural decoder with target sound.

In addition, the method may further include training the neural network that receives the output sound to output a sound quality index (SQI) and compares the sound quality index with a target sound quality index.

A method of controlling sound using a sound quality index-based generative artificial intelligence (AI) of the present disclosure may include inputting a controller area network (CAN) signal and a vibration signal of a vehicle to a neural encoder, forming, by a controller, a latent vector for the CAN signal and vibration signal processed in the neural encoder, outputting, by the latent vector, sound through a neural decoder, and outputting, by the output sound, a sound quality index (SQI) through a neural network, wherein the neural decoder may fixedly use the parameters of a neural decoder of which training is completed, and the neural network may fixedly use the neural network of which training is completed from the input of the CAN signal and vibration signal of the vehicle.

In addition, the method may include training the neural encoder by comparing the sound quality index output through the neural network with a target sound quality index.

A method of controlling sound using a sound quality index-based generative artificial intelligence (AI) may include inputting a controller area network (CAN) signal and a vibration signal of a vehicle to a neural encoder, forming, by a controller, a latent vector for the CAN signal and vibration signal processed in the neural encoder, outputting, by the latent vector, sound through a neural decoder, and outputting, by the output sound, a sound quality index (SQI) through a neural network, wherein the neural encoder may fixedly use the parameters of a neural encoder of which training is completed, the neural decoder may fixedly use the parameters of the neural decoder of which training is completed from the input of the sound, and the neural network may fixedly use the neural network of which training is completed from the input of the CAN signal and vibration signal of the vehicle.

In addition, the method may include comparing the sound quality index output through the neural network with a target sound quality index and determining the input CAN signal and vibration signal using an optimization algorithm.

A method of controlling sound using a sound quality index-based generative artificial intelligence (AI) may include inputting sound generated from a vehicle to a neural encoder, forming, by a controller, a latent vector for the sound in the neural encoder, outputting, by the latent vector, sound through a neural decoder, simultaneously training, by the controller, the neural encoder and the neural decoder by comparing the output sound with target sound and simultaneously training, by the sound, the neural encoder and the neural decoder for engine or motor generation sound, inputting a controller area network (CAN) signal and vibration signal of a vehicle to the neural encoder after completing the training of the neural encoder and the neural decoder, forming, by the controller, the latent vector for the CAN signal and vibration signal processed in the neural encoder, and outputting, by the latent vector, sound through the neural decoder, wherein the neural decoder may fixedly use the parameters of the neural decoder of which training by the input sound, the output sound, and the target sound is completed.

In addition, the controller may train the neural encoder by comparing the sound output from the neural decoder with the target sound.

In addition, the method may further include training the neural network that receives the output sound to output a sound quality index (SQI) and compares the sound quality index with a target sound quality index.

A method of controlling sound using a sound quality index-based generative artificial intelligence (AI) may include inputting sound generated from a vehicle to a neural encoder, forming, by a controller, a latent vector for the sound processed in the neural encoder, and outputting, by the latent vector, the sound through a neural decoder, wherein the controller may simultaneously train the neural encoder and the neural decoder by comparing the output sound with target sound, and the sound may simultaneously train the neural encoder and the neural decoder for engine or motor generation sound.

The method may include inputting a controller area network (CAN) signal and vibration signal of a vehicle to the neural encoder after completing the training of the neural encoder and the neural decoder, forming, by the controller, the latent vector for the CAN signal and vibration signal processed in the neural encoder, outputting, by the latent vector, sound through the neural decoder, wherein the parameters of the neural decoder of which training is completed may be fixedly used, and the controller may re-train the neural encoder by comparing the sound output from the neural decoder with the target sound.

The method may include inputting the CAN signal and vibration signal of the vehicle to the neural encoder of which re-training is completed after completing the re-training of the neural encoder, forming, by the controller, the latent vector for the CAN signal vibration signal processed in the neural encoder, outputting, by the latent vector, sound through the neural decoder of which training is completed; outputting, by the output sound, a sound quality index (SQI) through a neural network, training the neural network by comparing the sound quality index output through the neural network with the target sound quality index.

The method may include inputting the CAN signal and vibration signal of the vehicle to the neural encoder of which re-training is completed after completing the training of the neural network, forming, by the controller, the latent vector for the CAN signal vibration signal processed in the neural encoder, outputting, by the latent vector, sound through the neural decoder of which training is completed, and outputting, by the output sound, the sound quality index (SQI) through the neural network.

In addition, the method may include finely tuning and additionally training the neural encoder by comparing the sound quality index output through the neural network with the target sound quality index, and applying an optimization algorithm to the CAN signal and vibration signal of the vehicle by comparing the sound quality index output through the neural network with the target sound quality index.

### BRIEF DESCRIPTION OF THE DRAWINGS

FIG. 1 is a flowchart illustrating an example of a process for modeling generative artificial intelligence (AI) from vehicle signals and outputting the modeled generative AI from in-vehicle speakers.

FIG. 2 is a block diagram illustrating an example of a process of optimizing and personalizing sound.

FIG. 3 is a block diagram illustrating an example of a first process of the process of optimizing and personalizing sound.

FIG. 4 is a block diagram illustrating an example of a second process of the process of optimizing and personalizing sound.

FIG. 5 is a block diagram illustrating an example of application of fine tuning of the process of optimizing and personalizing sound.

FIG. 6 is a block diagram illustrating an example of application of an optimization algorithm of the process of optimizing and personalizing sound.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity. The term ‘controller’ may be ‘processor’ for processing at least one function or operation.

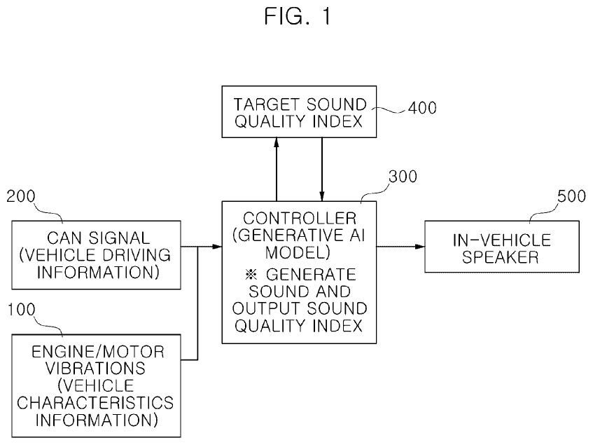

FIG. 1 is a flowchart illustrating an example of a process of modeling generative artificial intelligence (AI) from vehicle signals and outputting the modeled generative AI from in-vehicle speakers. For example, FIG. 1 shows a series of flowcharts for creating a generative AI model based on a target sound quality index from an input signal and implementing the generative AI model in in-vehicle speakers.

Referring to FIG. 1, to implement the present disclosure in a vehicle, vibration signals 100 from an engine and a motor as vehicle characteristic information, a controller area network (CAN) signal 200 representing vehicle driving information, and a controller 300 for modeling generative AI from the vibration signals and the CAN signal are included. The controller can control an in-vehicle speaker 500 according to a sound quality index 400 classified into powerful, dynamic, pleasant, and sporty.

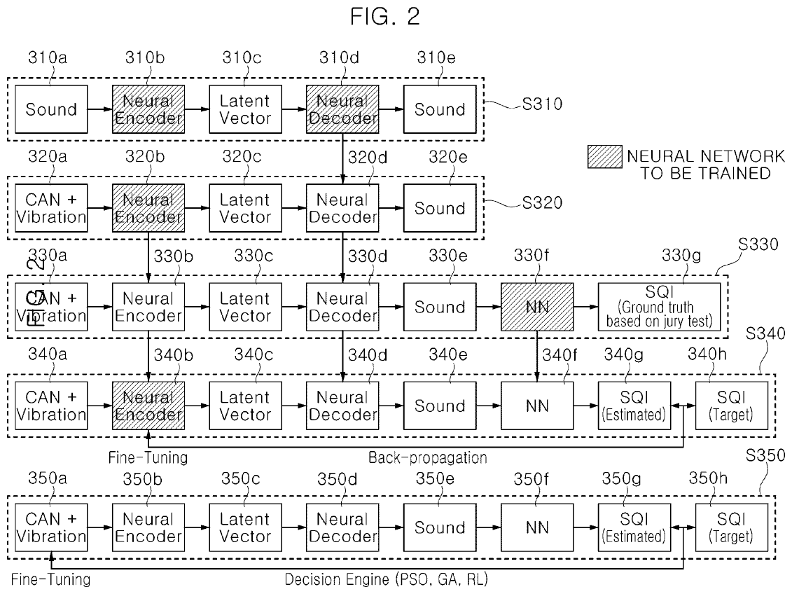

A first process S310, a second process S320, a third process S330, a fourth process S340, and a fifth process S350 as depicted in FIG. 2 can be sequentially performed in block units, and the block trained in the previous process can be used in the next process, and training can be performed in another block or the trained block can be permanently used. For example, a block can refer to an area in which a predetermined function or action is performed in the data flow, such as an input data or output data status, an encoder, a decoder, or a latent vector.

First, during the first process S310, a vehicle sound signal 310a can be received and a latent vector 310c can be generated in a neural encoder 310b. The latent vector can refer to a tool configured to compress data and extract features from the data and can compress data in various machine training models, particularly, an auto-encoder and a generative model. For example, the neural encoder 310b can extract features from the input sound and compress high-dimensional data into a low-dimensional latent vector based on the extracted features. The neural decoder 310d can receive the latent vector 310c, output sound, and can be configured to be trained so that output sound 310e is the same as input sound 310a.

The process of training the neural encoder and the neural decoder using the input sound, the output sound, and the latent vector can be performed in a neural network architecture such as an auto-encoder and can be performed in a method of converting the sound signal into a latent vector through the encoder and then restoring the latent vector back to the desired sound signal through the neural decoder, and the neural encoder and the neural decoder can be trained simultaneously to minimize a difference between the input sound and the restored output sound during the training process.

For example, the auto-encoder-based neural network is trained using any vehicle driving sound dataset, the input sound is encoded into a latent vector through the neural network, the latent vector is decoded through the neural network to output driving sound, and, in this case, a loss function is based on a difference between the output sound and target sound.

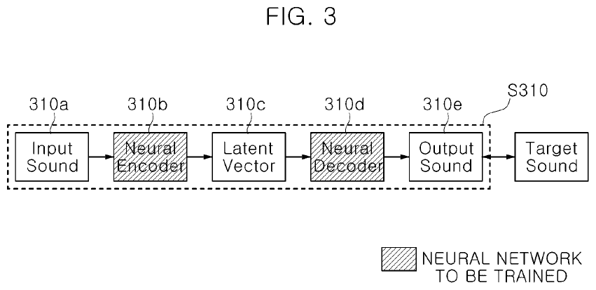

FIG. 3 is diagram illustrating an example of the first process S310 including input sound 310a, the neural encoder 310b, the latent vector 310c, the neural decoder 310d, and the output sound 310e and that the output sound 310e is compared with the target sound to train the neural encoder 310b and the neural decoder 310d.

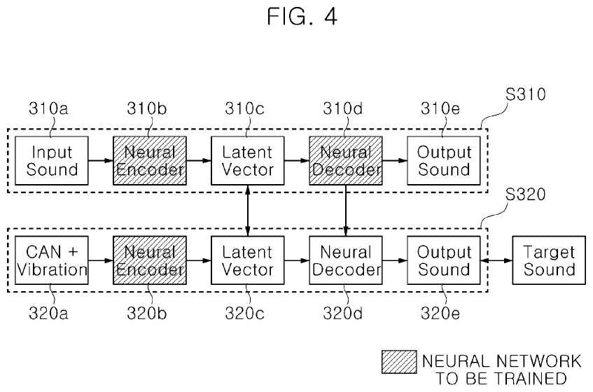

The second process S320 depicted in FIG. 4 can include adopting the neural decoder 310d trained in the first process S310, receiving vehicle signals, for example, a CAN signal and a vibration signal, as an input signal, generating a latent vector 320c through the neural encoder 320b, and outputting the sound 320e by the neural decoder 320d of the first process. For example, instead of the vehicle sound in the first process, a CAN signal vibration signal is input, and the neural encoder 320b is trained therefrom to minimize the difference from the output sound 320e. Specifically, parameters of the neural decoder 310d trained in the first process S310 are fixed without being further trained, and a new neural encoder 320b is trained so that signals related to vehicle driving information (vehicle speed, RPM, torque, acceleration, gear number, pedal, etc.) and engine/motor vibrations of the vehicle are input from the vehicle CAN signal to output driving sound. In this case, the loss function can be based on the difference between the output sound and the target sound and the difference between the latent vector 310c extracted in the first process S310 and the latent vector 320c extracted in the second process S320.

In the first process S310, the vehicle driving sound can be trained in the neural network based on the auto-encoder, and, in the second process S320, when the parameters of the neural decoder 310d is locked and further training is halted, the neural decoder 310d is finely tuned for generation through driving parameters such as vehicle speed, RPM, torque, acceleration, gear stage, pedal, and engine/motor vibrations of the vehicle, a neural network capable of outputting various driving sounds can be created when the driving parameters are input.

FIG. 4 is a diagram illustrating an example of the second process S320 including the input sound 320a, the neural encoder 320b, the latent vector 320c, the neural decoder 320d, and the output sound 320e. The neural decoder 320d of the second process S320 locks the parameters of the neural decoder 310d of the first process and uses the parameters as is, indicating the neural encoder 320b is trained by comparing the output sound with the target sound.

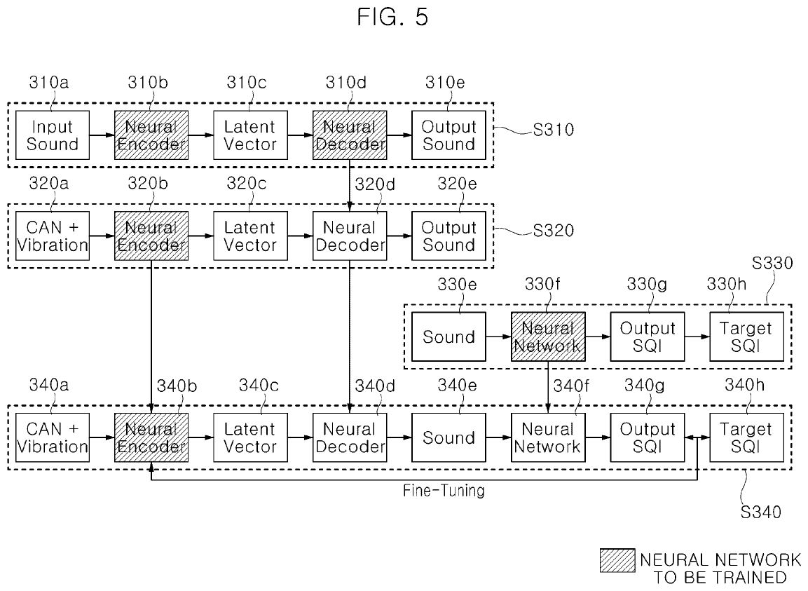

The third process S330 depicted in FIG. 5 can adopt the neural encoder 320b and the neural decoder 320d of the second process. After the input signals such as the CAN signal and the vibration signal 330a extract and compress important features from the latent vector 330c in the neural encoder, sound is output through the neural decoder. Training can be performed in a neural network (NN) 330f so that the output sound 330e matches a sound quality index (SQI) 330g that is the result of the listening evaluation by the jury test.

To this end, a sound quality index dataset can be constructed by conducting the listening evaluation for various in-vehicle driving sounds. The dataset can mix vehicle sound recorded indoors and vehicle sound generated based on the neural network. To secure the representativeness of the sound quality index, the evaluation can be conducted using in-vehicle driving sounds measured in various modes such as full-load acceleration, low/medium-load acceleration/deceleration, and regenerative braking, and the sound quality index (powerful, dynamic, pleasant, sporty) is evaluated as a score between 1 and 10.

For example, a neural network-based regression model that can estimate the sound quality index when the driving sound is input can be trained using the in-vehicle driving sound and the SQI as a dataset including the result of conducting the listening evaluation. In some implementations, the loss function can be based on the mean squared error (MSE) of the sound quality index (powerful, dynamic, pleasant, sporty) value.

After the above neural network learning types of the third process (S330), the fourth process (S340) and the fifth process (S350) have in common that the CAN signal and vibration signal of the vehicle are input to the above neural encoder of the third process (S330) that has finished relearning. As the neural decoder 340d and the neural network 340f of the fourth process S340, the neural decoder 330d and the neural network 330f of the third process can be used, and training can be performed in the neural encoder 340b. For example, the vehicle CAN signal and the vibration signal can be received to become output sound through the neural encoder 340b, the latent vector 340c, and the neural decoder 340d, and the SQI 340g can be output from the neural network 340f. The output SQI 340g can be an estimated value and can be compared with a target SQI 340h to propagate a difference from a target SQI 340h back to the neural encoder 340b for fine tuning.

For example, when a passenger presents a target sound quality index, optimal input signals (CAN signal and engine/motor vibration signals) can be found using an optimization algorithm so that driving sound having the corresponding sound quality index value may be output. In some implementations, the loss function is based on MSEs of four sound quality index values. After creating a mapping table so that the input signal is mapped to the optimal input signal, the optimal input signal to be mapped when the actual signal is input can generate driving sound through the neural network.

FIG. 5 is a block diagram illustrating an example of application of fine tuning of the process of optimizing and personalizing sound. For example, FIG. 5 shows a process in which the fourth process S340 proceeds, and the neural network 330f trained in the third process is locked as the neural network 340f in the fourth process, and the neural decoder 340d is locked as the neural decoder 320d in the second process. In training the neural network 330f in the third process S330, the CAN signal and vibration signal 330a, the neural encoder 330b, the latent vector 330c, and the output sound 330e through the neural decoder 330d can be selected from the output sound 320e in the second process, and the neural network 330f can be trained by comparing the output SQI 330g accordingly with the target SQI, and the trained neural network 330f can be used as the locked neural network 340f in the fourth process.

The fifth process S350 can have the same block elements as the fourth process S340. For example, the vehicle CAN signal and the vibration signal 350a are received to become output sound 350e through the neural encoder 350b, the latent vector 350c, and the neural decoder 350d, and the SQI 350g is output from the neural network 350f. The output SQI 350g can be an estimated value and compared with a target SQI 350h. Unlike the fourth process, the block that transmits the difference through back propagation for fine tuning is not the neural encoder, but the input data, that is, the input of the CAN signal and vibration signal, and, to this end, a decision engine can make an optimal decision using an optimization and training algorithm such as particle swarm optimization (PSO), a genetic algorithm (GA), or reinforcement training (RL).

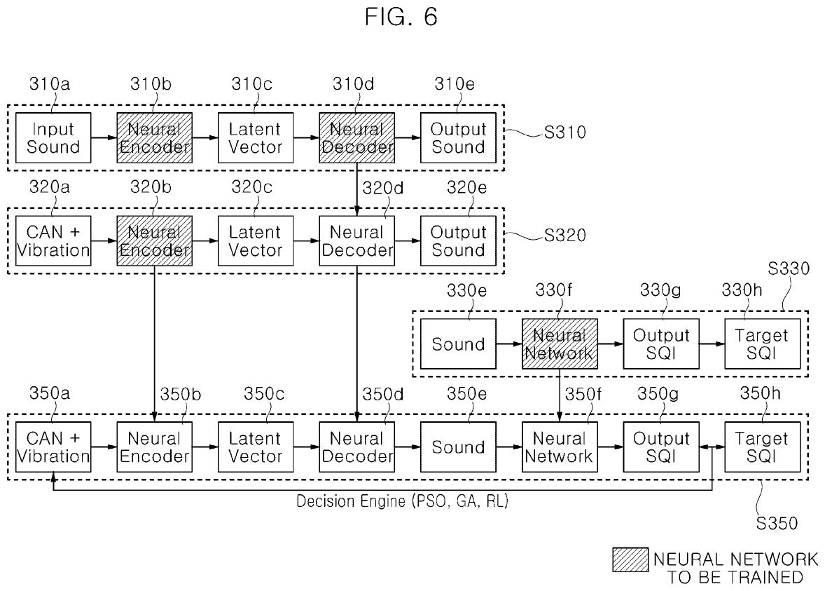

FIG. 6 is a block diagram illustrating an example of application of an optimization algorithm of the process of optimizing and personalizing sound. FIG. 6 shows a process in which the fifth process S350 proceeds. The neural network 330f trained in the third process S330 is locked as the neural network 350f in the fifth process S350. The neural decoder 320d in the second process S320 is locked as the neural decoder 350d in the fifth process.

The neural encoder 320b in the second process S320 can be locked as the neural encoder 350b in the fifth process S350. In training the neural network 330f in the third process S330, the CAN signal and vibration signal 330a, the neural encoder 330b, the latent vector 330c, and the output sound 330e through the neural decoder 330d can be selected from the output sound 320e in the second process, and the neural network 330f can be trained by comparing the output SQI 330g accordingly with the target SQI, and the trained neural network 330f can be used in a state of being locked in the fifth process S350.

Using an additional neural network (regression model) trained based on a dataset on various driving sound sources and sound quality index values based on the listening evaluation of the corresponding sound sources, a sound quality index of the driving sound generated through the neural network can be estimated.

Alternatively, optimization can be performed based on a separate optimization algorithm, such as a genetic algorithm, particle swarm optimization, and reinforcement training. Through this process, when a passenger presents a desired sound quality index, driving sound can be generated by automatic optimization based on the sound quality index value, thereby creating distinctive and personalized driving sound.

The first process S310 can be related to a method of controlling sound using a sound quality index-based generative AI, and to a process of inputting sound generated from a vehicle to a neural encoder, forming, by a controller, a latent vector for the sound processed in the neural encoder, and outputting, by the latent vector, the sound through a neural decoder, in which the controller simultaneously trains the neural encoder and the neural decoder by comparing the output sound with target sound, and the sound simultaneously trains the neural encoder and the neural decoder for engine or motor generation sound.

After the training of the neural encoder and the neural decoder is completed in the first process S310, the second process S320 can be performed. For example, the second process S320 includes inputting the CAN signal and vibration signal of the vehicle to the neural encoder, forming, by the controller, the latent vector for the CAN signal and vibration signal processed in the neural encoder, and outputting, by the latent vector, sound through the neural decoder.

The parameters of the neural decoder in the first process S310, once training is completed, are locked and used as is in the second process S320, and the controller can re-train the neural encoder in the second process S320 by comparing the sound output from the neural decoder with the target sound.

The third process S330 can include inputting the CAN signal and vibration signal of the vehicle to the neural encoder of which re-training is completed after the re-training of the neural encoder is completed in the second process S320, forming, by the controller, the latent vector for the CAN signal and vibration signal processed in the neural encoder, and outputting, by the latent vector, the sound through the neural decoder of which training is completed, and outputting, by the output sound, a sound quality index (SQI) through a neural network, in which the neural network can be trained by comparing the sound quality index output through the neural network with the target sound quality index.

After the training of the neural network is completed in the third process S330, the fourth process S340 and the fifth process S350 can include commonly inputting the CAN signal and vibration signal of the vehicle to the neural encoder of which re-training is completed, forming, by the controller, the latent vector for the CAN signal and vibration signal processed in the neural encoder, outputting, by the latent vector, the sound through the neural decoder of which training is completed, and outputting, by the output sound, a sound quality index (SQI) through the neural network. However, in the fourth process S340, the neural encoder may be finely tuned and additionally trained while the sound quality index output through the neural network is compared with the target sound quality index, and, in the fifth process S350, the sound quality index output through the neural network can be compared with the target sound quality index to apply the optimization algorithm to the CAN signal and vibration signal of the vehicle.

What is claimed is:

1. A method of controlling sound using a sound quality index-based generative artificial intelligence (AI), the method comprising:
inputting, by a controller, sound generated from a vehicle to a first neural encoder;
generating a first latent vector for the sound in the first neural encoder; and
outputting sound through a first neural decoder based on the first latent vector.

2. The method of claim 1, wherein the controller is configured to simultaneously train the first neural encoder and the first neural decoder by comparing the output sound with target sound.

3. The method of claim 2, wherein the sound received at the first neural encoder is generated from an engine or a motor of the vehicle.

4. The method of claim 3, further comprising:
inputting, by a controller, a controller area network (CAN) signal and a vibration signal of the vehicle to a second neural encoder;
generating a second latent vector for the CAN signal and the vibration signal processed at the second neural encoder; and
outputting sound through a second neural decoder based on the second latent vector,
wherein the second neural decoder is configured to use the first neural decoder of which training is completed.

5. The method of claim 4, wherein a loss function is based on a difference between the first latent vector for the sound generated of the vehicle and the second latent vector for the CAN signal and vibration signal of the vehicle.

6. The method of claim 5, wherein the controller is configured to train the second neural encoder by comparing the sound output from the second neural decoder with target sound.

7. The method of claim 6, further comprising training a first neural network configured to receive the output sound to thereby output a sound quality index (SQI) and compare the sound quality index with a target sound quality index.

8. The method of claim 7, further comprising:
inputting, by a controller, a controller area network (CAN) signal and a vibration signal of the vehicle to a third neural encoder;
generating a third latent vector for the CAN signal and vibration signal processed at the third neural encoder;
outputting sound through a third neural decoder based on the third latent vector; and
generating a sound quality index (SQI) from the output sound through a second neural network,
wherein the third neural decoder is configured to use the second neural decoder, and
wherein the second neural network is configured to use the first neural network.

9. The method of claim 8, further comprising training the third neural encoder by comparing the sound quality index output with a target sound quality index through the second neural network.

10. The method of claim 7, further comprising:
inputting, by a controller, a controller area network (CAN) signal and a vibration signal of the vehicle to a third neural encoder;
generating a third latent vector for the CAN signal and vibration signal processed in the third neural encoder;
outputting sound through a third neural decoder based on the third latent vector; and
generating a sound quality index (SQI) from the output sound through a second neural network,
wherein the third neural encoder is configured to use the second neural encoder,
wherein the third neural decoder is configured to use the second neural decoder, and
wherein the second neural network is configured to use the first neural network.

11. The method of claim 10, further comprising:
comparing the sound quality index output through the second neural network with a target sound quality index; and
determining the CAN signal and vibration signal using an optimization algorithm.

12. A method of controlling sound using a sound quality index-based generative artificial intelligence (AI), the method comprising:
inputting, by a controller, sound generated from a vehicle to a first neural encoder;
generating a first latent vector for the sound in the first neural encoder;
outputting sound through a first neural decoder based on the first latent vector;
training the first neural encoder and the first neural decoder by comparing the output sound with a target sound, the sound being generated from an engine or a motor of the vehicle;
inputting, by a controller, a controller area network (CAN) signal and vibration signal of the vehicle to a second neural encoder;
generating a second latent vector for the CAN signal and vibration signal processed in the second neural encoder; and
outputting sound through a second neural decoder based on the second latent vector,
wherein the second neural decoder is configured to use the first neural decoder of which training is completed by the received sound, the output sound, and the target sound.

13. The method of claim 12, wherein the controller is configured train the second neural encoder by comparing the sound output from the second neural decoder with the target sound.

14. The method of claim 13, further comprising training a neural network configured to receive the output sound to thereby output a sound quality index (SQI) and compare the sound quality index with a target sound quality index.

15. A method of controlling sound using a sound quality index-based generative artificial intelligence (AI), the method comprising:
inputting, by a controller, sound generated from a vehicle to a first neural encoder;
generating a first latent vector for the sound at the first neural encoder;
outputting sound through a first neural decoder based on the first latent vector;
training the first neural encoder and the first neural decoder by comparing the output sound with target sound, the sound being generated from an engine or a motor of the vehicle;
inputting, by a controller, a controller area network (CAN) signal and vibration signal of a vehicle to a second neural encoder;
generating a second latent vector for the CAN signal and vibration signal processed at the second neural encoder; and
outputting sound through a second neural decoder based on the second latent vector, wherein the second neural decoder is configured to use the first neural decoder of which training is completed by the received sound, the output sound, and the target sound;
inputting, by a controller, the CAN signal and vibration signal of the vehicle to a third neural encoder, wherein the third neural encoder is configured to use the second neural encoder;
generating, a third latent vector for the CAN signal vibration signal processed at the third neural encoder;
outputting sound through a third neural decoder, wherein the third neural decoder is configured to use the second neural encoder;
generating a sound quality index (SQI) from the output sound through a first neural network;
training the first neural network by comparing the sound quality index output through the first neural network with a target sound quality index;
inputting, by a controller, the CAN signal and vibration signal of the vehicle to a fourth neural encoder, wherein the fourth neural encoder is configured to use the third neural encoder;
generating a fourth latent vector for the CAN signal vibration signal processed at the fourth neural encoder;
outputting sound through a fourth neural decoder of which training is completed based on the fourth latent vector; and
generating a sound quality index (SQI) from the output sound through a second neural network, wherein the second neural network is configured to use the first neural network.

16. The method of claim 15, comprising tuning and additionally training the fourth neural encoder by comparing the sound quality index output through the second neural network with the target sound quality index.

17. The method of claim 15, comprising applying an optimization algorithm to the CAN signal and vibration signal of the vehicle by comparing the sound quality index output through the second neural network with the target sound quality index.

18. A method of controlling sound using a sound quality index-based generative artificial intelligence (AI), the method comprising:
inputting, by a controller, sound generated from a vehicle to a first neural encoder;
generating a first latent vector for the sound at the first neural encoder;
outputting sound through a first neural decoder based on the first latent vector;
training the first neural encoder and the first neural decoder by comparing the output sound with target sound, the sound being generated from an engine or a motor of the vehicle;
inputting, by a controller, a controller area network (CAN) signal and vibration signal of a vehicle to a second neural encoder;
generating a second latent vector for the CAN signal and vibration signal processed at the second neural encoder; and
outputting sound through a second neural decoder based on the second latent vector, wherein the second neural decoder is configured to use the first neural decoder of which training is completed by the received sound, the output sound, and the target sound;
inputting, by a controller, the CAN signal and vibration signal of the vehicle to a third neural encoder, wherein the third neural encoder is configured to use the second neural encoder;
generating, a third latent vector for the CAN signal vibration signal processed at the third neural encoder;
outputting sound through a third neural decoder, wherein the third neural decoder is configured to use the second neural encoder;
generating a sound quality index (SQI) from the output sound through a first neural network;
training the first neural network by comparing the sound quality index output through the first neural network with a target sound quality index;
inputting, by a controller, the CAN signal and vibration signal of the vehicle to a fifth neural encoder, wherein the fifth neural encoder is configured to use the second neural encoder;
generating a fifth latent vector for the CAN signal vibration signal processed at the fifth neural encoder;
outputting sound through a fifth neural decoder, wherein the fifth neural decoder is configured to use the second neural decoder; and
generating a sound quality index (SQI) from the output sound through a third neural network, wherein the third neural network is configured to use the first neural network.

19. The method of claim 18, comprising applying a Decision Engine to the CAN signal and vibration signal of the vehicle by comparing the sound quality index output through the third neural network with the target sound quality index.

20. An apparatus for controlling sound using a sound quality index-based generative artificial intelligence (AI), the apparatus comprising:
a controller configured to input sound generated from a vehicle to a first neural encoder, wherein the controller configured to generate a first latent vector for the sound in the first neural encoder, and to output sound through a first neural decoder based on the first latent vector.
